(19) United States
(12) Patent Application Publication
(10) Pub. No.: US 2022/0188804 A1
(43) Pub. Date: Jun. 16, 2022

(54) METHOD AND SYSTEM FOR FACILITATING MOBILE CONTACTLESS PAYMENTS

(71) Applicant: Strike Technology Limited, Blackrock (IE)

(72) Inventors: Charles Dowd, Dublin (IE); Oliver Cavanagh, Dublin (IE)

(21) Appl. No.: 17/120,940

(22) Filed: Dec. 14, 2020

(51) Int. Cl. G06Q 20/32; G06Q 20/22; G06Q 20/36

(52) U.S. Cl. CPC G06Q 20/3278; G06Q 20/3674; G06Q 20/227

(57) ABSTRACT

The present application provides an efficient method of registering users with a payment system using NFC tags and thereafter allowing a user to receive payment from another person by presenting their NFC tag to the mobile phone of the other person. The efficient method of registering users addresses a problem of how to register users for an electronic payment system without having to send them a card or other device by post.

### FIELD OF THE INVENTION

The present application relates to a method and system for facilitating contactless payment.

### BACKGROUND

There is a general problem with making payments as cash becomes less prevalent in that it becomes difficult to pay businesses, individuals or charities where they do not have a payment system in place.

A simple example is that of food delivery persons where conventionally a tip might be paid upon delivery of the food. If cash is unavailable to give a tip, then generally there is no easy way to provide a tip. Some delivery services include this option as part of the ordering process but there may be a reluctance on the part of the person receiving the delivery to pay up front for a delivery they haven't received. At the same time, even if this is provided as an option post-delivery, the person may be reluctant to pay the delivery service a tip for reasons of uncertainty as to whether the delivery person will receive the tip or for example whether it is used to pay the wages of the delivery person. Another example is where a charity is collecting donations where conventionally a donation would be paid with cash and coins, there is no easy way to take a donation without cash.

It would be possible for each delivery driver or charity collector to have a payment terminal of their own for receiving tips, but these tend to be expensive relative to the value of tips or donations received.

### SUMMARY

The present application provides method and systems which allows users to use RFID tags as payment terminals for themselves. According to a first aspect, a method of using a payment service is provided for making payment between users.

The method suitable comprises the steps of:

providing a first tag of a plurality of tags to a first user having a first personal communications device having an NFC reader, each of the plurality of tags storing tag information comprising an address for a server associated with the payment service and a unique identifier for the respective tag; and
employing the NFC reader to read the tag information from the first tag; transmitting from the first personal communications device the unique identifier of the first tag to the server. When received at the server, the server performs a check, using the unique identifier, to determine whether the first tag has previously been associated with a user.

Once registered, a payment process will ensue when the first tag is presented to a second personal communications device, of a second user, having an NFC reader. When the tag is tapped against the NFC reader of the second personal communications device, the information is read from the first tag and then transmitted from the second personal communications device to server with the unique identifier. At the server, the tag is identified as being associated with the first user and in response the server provides the second user with a payment interface to allow them to make a payment to the first user. The step of identifying the tag is associated with the first user may comprise the additional step of identifying payment methods accepted by the first user and the step of providing the payment interface comprises presenting the identified payment methods accepted. The step of providing the payment interface may comprise providing an option to the second user to register with the payment service. Upon completion of the payment, the server may send a notification to the first user that a payment has been received.

A second aspect provides a system which in turn enables a payment service for facilitating payment between users. The system suitably comprises a plurality of tags, a first personal communications device and a server. Each of the plurality of tags suitably store tag information comprising an address and a unique identifier for the respective tag. The first personal communications device suitably has an NFC reader configured to read the tag information from a first tag of the plurality of tags and in response successfully reading tag information from the first tag to send the tag information of the first tag as a first request to the address specified in the tag information of the first tag. The server is responsive to requests received at the specified address, the server being configured in response to receiving the first request to perform a check, using the unique identifier, to determine whether the first tag has previously been associated with a user; and where a tag has not previously been associated with a user sending a response to the request to the first personal communications device to allow the generation of a first association interface on the personal communications device to allow user of the first personal communications device to submit a second request to the server, the second request requesting that an association be made with the first tag on the payment service and for the first personal communications device to forward this second request to the server; and the server being further configured in response to this second request to effect a registration of the first tag with the first user at the payment service. Suitably, the server comprises a database and the server is configured to associate the user with the tag by creating an entry in the database linking the first tag to the user. After registration, to facilitate a payment, the system suitably further comprises a second personal communications device having a NFC reader. The second personal communications device is configured upon the presentation of the first tag to its NFC reader to read the tag information from the first tag and to transmit unique identifier to the server. The server is configured upon receipt of this request from the second personal communications device to provide the second personal communications device with a payment interface for presentation to the user of the second personal communications device to allow them to make a payment to the first user. The server is suitably configured when identifying the tag is associated with the first user to identify payment methods accepted by the first user and to present the identified payment methods in the payment interface. Suitably, the payment interface comprises a feature allowing the second user to register with the payment service. Suitably, upon completion of the payment, the server is configured to send a notification to the first user that a payment has been received.

A further aspect comprises a method performed at a server having a web interface configured to receive requests by means of URL. The method comprises receiving a request at the server from a personal communications device, the URL including a unique identifier for a first tag. The server parses the unique identifier from the URL and interrogates a database to determine whether the unique identifier is currently associated with a user.

Upon determining that the unique identifier is not currently associated with a user, the server provides an interface to the personal communications device to allow a user of the personal communications device to complete a registration and upon receiving this registration to register the user in the database and associate the user with the unique identifier for the first tag. In the alternative, upon determining that the unique identifier is currently associated with an existing user, the server provides an interface to the personal communications device to allow a user of the personal communications device to make a payment to the existing user. Upon completion of a payment, sending a notification to the first user that a payment has been received.

According to one aspect, a method for facilitating mobile contactless payment includes providing a NFC tag encoded with a URL including a server address and a unique identifier, receiving a query sent to the URL over a network from a first user device in response to the first user device reading the NFC tag, and parsing the query to extract the unique identifier. The method also includes determining whether the unique identifier is available or live by searching a database for the unique identifier, and retrieving a first hero record stored within the database and associated with the unique identifier in response to determining that the unique identifier is live. The first hero record is associated with a first hero user and includes at least payment addressing information specific to the first hero user and associated with at least one payment service. The method also includes sending a payment interface to the first user device indicating the at least one payment service of the first hero record, receiving a payment service selection from the first user device, and redirecting the first user device to a payment server associated with the selected payment service using the payment addressing information of the first hero record. The method includes receiving a query sent to the URL over the network from a second user device in response to the second user device reading the NFC tag, and claiming the unique identifier and making it live in response to determining the unique identifier is available. Claiming the unique identifier includes requesting identifying information, contact information, and payment addressing information associated with at least one payment service from a second hero user, through the second user device, and creating a second hero record within the database. The second hero record is associated with the second hero user and includes the unique identifier, the identifying information, the contact information, and the payment addressing information specific to the second hero user. The first user device and the second user device are mobile devices. The second user device is redirected to an interface provided directly from a payment server, for each of the at least one payment service identified by the second hero user. The at least one payment service includes a mobile wallet service.

Particular embodiments may comprise one or more of the following features. Any sensitive payment information requested through the first user device may be sent directly to the payment server. The query sent to the URL from the first user device may include a striker identifier associated with a striker record within the database. The striker record may include at least payment addressing information specific to a striker user associated with the striker identifier. The payment interface sent to the first user device may indicate at least one payment service common to the striker record and the first hero record. Redirecting the first user device to the payment server associated with the selected payment service may use the payment addressing information of the first hero record and the striker record. The payment addressing information of the first hero record may be associated with a plurality of payment services, each payment service associated with a different payment server.

According to another aspect of the disclosure, a method for facilitating mobile contactless payment includes providing a NFC tag encoded with a URL comprising a server address and a unique identifier, receiving a query sent to the URL over a network from a first user device in response to the first user device reading the NFC tag, and parsing the query to extract the unique identifier. The method also includes determining whether the unique identifier is available or live by searching a database for the unique identifier, and retrieving a first hero record stored within the database and associated with the unique identifier in response to determining that the unique identifier is live. The first hero record is associated with a first hero user and includes at least payment addressing information specific to the first hero user and associated with at least one payment service. The method includes sending a payment interface to the first user device indicating the at least one payment service of the first hero record, receiving a payment service selection from the first user device, and redirecting the first user device to a payment server associated with the selected payment service using the payment addressing information of the first hero record. The first user device is a mobile device.

Particular embodiments may comprise one or more of the following features. Any sensitive payment information requested through the first user device may be sent directly to the payment server. The method may further include receiving a query sent to the URL over the network from a second user device in response to the second user device reading the NFC tag, and claiming the unique identifier and making it live in response to determining the unique identifier is available. Claiming the unique identifier may include requesting identifying information, contact information, and/or payment addressing information associated with at least one payment service from a second hero user, through the second user device, as well as creating a second hero record within the database. The second hero record may be associated with the second hero user and may include the unique identifier, the identifying information, the contact information, and/or the payment addressing information specific to the second hero user. The second user device may be a mobile device. The second user device may be redirected to an interface provided directly from a payment server, for each of the at least one payment service identified by the second hero user. The at least one payment service may include a mobile wallet service. The at least one payment service may include a card processing service. The payment addressing information of the first hero record may be associated with a plurality of payment services, each payment service associated with a different payment server. The query sent to the URL from the first user device may include a striker identifier associated with a striker record within the database. The striker record may include at least payment addressing information specific to a striker user associated with the striker identifier. The payment interface sent to the first user device may indicate at least one payment service common to the striker record and the first hero record. Redirecting the first user device to the payment server associated with the selected payment service may use the payment addressing information of the first hero record and the striker record.

According to yet another aspect of the disclosure, a system for facilitating mobile contactless payment includes an NFC tag encoded with a URL having a server address and a unique identifier, and a database including a first hero record associated with a first hero user and having the unique identifier, payment addressing information specific to the first hero user and associated with at least one payment service. The system also includes a server having a processor, a memory, and a network interface communicatively coupled to a network through the server address. The server is also communicatively coupled, through the network, to at least one payment server associated with each of the at least one payment service. The server is configured to receive a query sent to the URL over the network from a first user device in response to the first user device reading the NFC tag. The first user device is a mobile device. The system is also configured to parse the query to extract the unique identifier, determine whether the unique identifier is available or live by searching the database for the unique identifier, retrieve the first hero record from the database in response to determining that the unique identifier is live, send a payment interface to the first user device indicating the at least one payment service of the first hero record, receive a payment service selection from the first user device, and redirect the first user device to the payment server associated with the selected payment service, using the payment addressing information of the first hero record.

Particular embodiments may comprise one or more of the following features. Any sensitive payment information requested through the first user device may be sent directly to the payment server. The system may further be configured to receive a query sent to the URL over the network from a second user device in response to the second user device reading the NFC tag, and claim the unique identifier and making it live in response to determining the unique identifier is available. Claiming the unique identifier may include requesting identifying information, contact information, and/or payment addressing information associated with at least one payment service from a second hero user, through the second user device, and creating a second hero record within the database. The second hero record may be associated with the second hero user and may include the unique identifier, the identifying information, the contact information, and/or the payment addressing information specific to the second hero user. The server may be configured to redirect the second user device to an interface provided directly from a payment server, for each of the at least one payment service identified by the second hero user. The at least one payment service may include a mobile wallet service. The at least one payment service may include a card processing service. The payment addressing information of the first hero record may be associated with a plurality of payment services, each payment service associated with a different payment server. The query sent to the server address from the first user device may include a striker identifier associated with a striker record within the database. The striker record may include at least payment addressing information specific to a striker user associated with the striker identifier. The payment interface sent to the first user device may indicate at least one payment service common to the striker record and the first hero record. Redirecting the first user device to the payment server associated with the selected payment service may use the payment addressing information of the first hero record and the striker record.

Other aspects and features of the present application will be understood by those of ordinary skill in the art from a review of the following description of examples in conjunction with the accompanying figures.

In the present application, the terms “about”, “approximately”, and “substantially” are meant to cover variations that may exist in the upper and lower limits of the ranges of values, such as variations in properties, parameters, and dimensions. In a non-limiting example, the terms “about”, “approximately”, and “substantially” may mean plus or minus 10 percent or less.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. A method or algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “detecting”, “comparing”, “validating”, “providing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods mentioned above. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below. In addition, the present specification also implicitly discloses a computer program, in that it would be apparent to the person skilled in the art that the individual steps of the method described above may be put into effect by computer code which may be implemented co-operatively on multiple devices. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium. The computer program when loaded and executed on such a computer effectively results in an apparatus that implements the steps of the preferred method.

Various embodiments of the invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

### DESCRIPTION OF DRAWINGS

The accompanying figures, which together with the detailed description below are incorporated in and form part of the specification, serve to illustrate various embodiments and to explain various principles and advantages in accordance with a present embodiment, by way of example only, and in which:

FIG. 1A is a system view of an exemplary aspect of the present application;

FIG. 1B is a schematic view of the database of FIG. 1A,

FIG. 2 illustrates a method of making a payment which may be employed in the system of FIG. 1A;

FIG. 3 is a swim line process flow illustrating the steps and entities involved in a method according to an exemplary aspect of the present application;

FIG. 4 is an exemplary life cycle flow for a tag in a further exemplary aspect of the present application;

FIG. 5 is an exemplary life cycle flow for a user in a further exemplary aspect of the present application;

FIG. 6 is an exemplary life cycle flow for a payment in a further exemplary aspect of the present application;

FIG. 7 is a system view of a personal communications device as might be employed in the system of FIG. 1A;

FIG. 8 is a view of a tag as might be employed in the system of FIG. 1A; and

FIG. 9 is a system view of a server as might be employed in the system of FIG. 1A.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present disclosure.

### DETAILED DESCRIPTION

The present application provides a system and method for allowing one person make a cashless payment to another person without the need for dedicated payment terminals or the like.

To achieve this the present inventors have realised that a low cost tag, for example an RFID tag, may be employed to perform the role of a payment terminal to allow a payment to be made from a user with a personal communications device to a user registered with the tag.

The application uses the technology of Near Field Communication (NFC) communication. NFC is a short-range communications method which uses inductive coupling to connect two NFC devices over a relatively short distance, which is generally less than four cm. The protocol for NFC communication is standardised in ECMA-340 and ISO/IEC 18092, the entire contents of which are incorporated by reference. These standards specify the modulation schemes, coding, transfer speeds and frame format of the RF interface of NFC devices, as well as initialization schemes and conditions required for data collision-control during initialization for both passive and active NFC modes. They also define the transport protocol, including protocol activation and data-exchange methods. The air interface for NFC is standardized in ISO/IEC 18092/ECMA-340-Near Field Communication Interface and Protocol-1 (NFCIP-1) and ISO/IEC 21481/ECMA-352-Near Field Communication Interface and Protocol-2 (NFCIP-2), the entire contents of which are also included by reference.

More particularly the present application employs NFC compatible personal communication devices, such as mobile telephones which can function as a proximity coupling device (PCD) and proximity integrated circuit cards (PICC), oftentimes referred to as NFC tags, RFID cards or proximity cards. The technology behind these are defined in ISO14443, the entire contents of which are incorporated by reference.

For ease of explanation, the description will be described with reference to an exemplary situation, where a customer can tip a service person.

In this exemplary mode of operation, a first person, for example a customer, referred to hereinafter as a “Striker” can make a payment (for example a tip or gratuity) to a second person, typically a service person (for example, a waiter, server, hairdresser, busker etc), referred to hereinafter as a “Strike Hero” or “Hero”.

The system enables a striker to make a payment to a strike hero using a plurality of different methods in a simple and efficient manner.

At the same time, it allows a strike hero to sign up for and receive a payment in a simple and efficient manner.

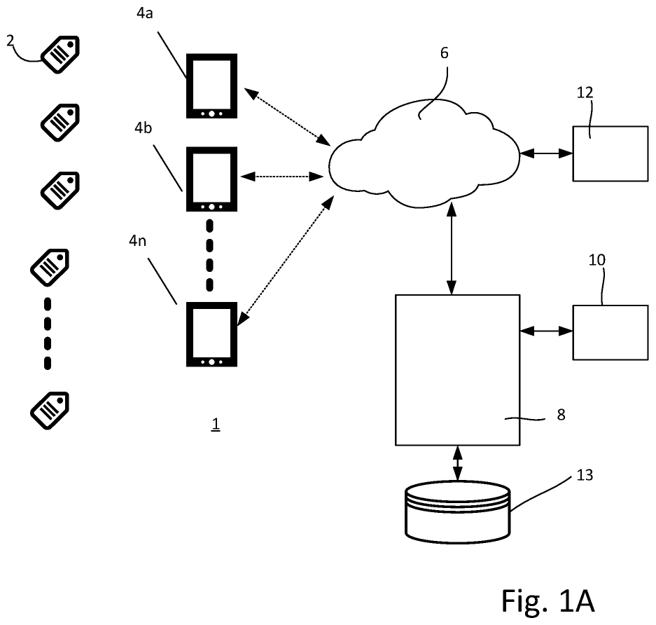

The present application will now be explained with reference to an exemplary system shown in FIG. 1A. The system comprises a plurality of tags 2, a plurality of personal communication devices 4 (e.g. first user device 4a, second user device 4b, etc.) which are NFC enabled, e.g. mobile phones, and a server 8 which is accessible through a network 6 (e.g. the Internet, etc.).

As shown, the server 8 is also communicatively coupled to a database 13, which comprises hero records describing recipients of payments, and striker records describing payers. These records will be discussed in greater detail with respect to FIG. 1B, below.

Each of the plurality of tags is preloaded with an identifier which is unique to each individual tag. As an example, the unique identifier may be a Base 64, RFC 7515 identifier. The tags may each be printed with an identifier which may be the same or different to allow a user to visually identify a tag.

The unique identifier is stored as a part of a URL on the tag. The URL may for example identify a web address of the server. It may also identify a service on the server and a protocol to be employed. Thus it may be of the form: [protocol][web/IP address][directory/service][Tag identifier], as shown in the example below:

https://strike.tips/tags/0zqtLS9I_0GfxSRvOQFymA
where the protocol is identified as https, the web server address is identified as strike.tips, the service is identified as tags and the unique tag identifier is identified as 0zqtLS9I_0GfxSRvOQFymA. It will be appreciated that this URL may be considered as a global unique identifier (GUID). When the tag is presented to a compatible NFC reader device, the GUID will be read from the tag.

Although, NFC Tag with NDEF can have formatted data up to 137 bytes, the example above employs 47 bytes for the URL with 25 bytes for the prefix (https://strike.tips/tags/) and 22 bytes for the tag identifier (tagID: 0zqtLS9I_0GfxSRvOQFymA). However, it will be appreciated that other tag data or identifiers may be included as required. Similarly, the address of the web server is merely exemplary. Accordingly, it will be understood that the URL is not limited to 47 bytes.

Each tag can serve to effect a plurality of different functions depending on the nature of the user. More particularly a tag may first be tapped by a user with their mobile phone to allow them to register with the server as a strike hero, or hero. After this registration is completed, the tag in effect becomes the payment terminal for the registered user (strike hero). Thereafter when other users (strikers) tap the tag with their mobile phones, it allows them to make a payment to the strike hero registered with the tag.

The exemplary roles\functions involved in the system comprise one or more the following Strikers, Strike Heroes and a Strike Web App which is made available at the server.

The web app provides different functions depending on the type of the user accessing the service.

In addition to or in place of the Web App, apps may be provided for download onto a user's mobile device. The apps may be made available from a suitable app repository, e.g. the PLAYSTORE provided by GOOGLE or the APPSTORE provided by APPLE, for download by a user to their mobile device. For example, a Striker App may be provided to provide a striker with the functionality they would experience normally using the Web App. Similarly, a Web Hero App may be provided to provide a strike hero with the functionality they would experience normally using the Web App. It will be appreciated that different functionality may be provided between the Web App and the downloaded apps.

FIG. 1B is a schematic view of a non-limiting example of a database 13 and the records contained within. According to various embodiments, the database 13 may comprise a plurality of hero records 14, associated with payment recipients, or hero users. As shown, a hero record 14 includes a unique identifier 16 (associated with a tag, hero identifier, striker identifier, etc.), identifying information 17 (e.g. name, employer, address, etc.), contact information 18 (e.g. email address, phone number, etc.), and payment addressing information 19. In the context of the present description and the claims that follow, payment addressing information 19 is information needed to transfer funds to a payment account belonging to the hero user associated with that record. The payment addressing information 19 is not sensitive information, according to various embodiments, but rather information that is safe to make publicly available, and is only useable to send money to the hero, and not gain any further access. Examples include, but are not limited to, a user ID, a user name, an account number, a wallet public key, and the like.

According to various embodiments, any transmission of sensitive financial information (e.g. personal data such as SSN, passwords, private keys, etc.) that is required may be confined to interactions directly between the user and a payment server controlled and secured by the payment service. For example, in some embodiments, such information may be provided directly to the payment service after the contemplated server has redirected the user's device to the payment server operated by and secured by that particular payment service.

In some embodiments, the payment addressing information 19 may include server addresses for the payment server associated with a particular payment service, data object formats and protocols for interacting with a payment service through an API, and the like.

Some embodiments of the contemplated system may also allow for payers, or striker users, establish an account that permits them to provide the needed information once, and then for subsequent transactions, they only need to authenticate and log in to their account, and finish the transaction using the stored information, as will be discussed further, below.

An advantage of the contemplated system and method is that it provides a unified experience for both payer and recipient. While there are a wide range of payment technologies available today, they all operate slightly differently, and none are universally adopted. Using conventional systems, a customer may be registered with one service and the delivery person may be registered with another. In order for a tip to be transacted, one of the two individuals would need to register/authenticate/interact with a payment service that may be new to them. And this is after working out what the options are. In most cases, the path of least resistance may simply be to not perform the transaction. The contemplated system and method provides a universal interface that can integrate disparate payment systems, and can be adapted for use with systems not yet in existence, or adapt with new protocols and regulations. In some embodiments, the contemplated system may even bridge otherwise isolated payment services, further streamlining the process without taking on the task (or liability) associated with securing sensitive financial information. Using the contemplated system would not require a user, payer or recipient, to place faith in a new system, but rather continue to trust systems they already use. In some embodiments, the contemplated system may further facilitate the transaction by only presenting to the striker options that they have in common with the hero (e.g. if they both have PayPal accounts, that option is presented).

An exemplary summary of the roles/functions, according to various embodiments, is set forth below in table 1. It should be noted that while all of the listed “available functions” may be implemented in some embodiments, other embodiments may implement only a subset of the listed functions below.

TABLE 1

| | | Functions Available, in |
|---|---|---|
| Term | Description | some embodiments |
| Striker | A paying user, who can tip | Can tip without signing up |
| | another user (Hero) by | Can tip with an entering |
| | tapping a tag | payment card details |
| | | Can tip with a payment |
| | | service (e.g. REVOLUT ™, |
| | | PAYPAL ™, STRIPE ™ |
| | | etc) if the Hero is |
| | | registered with that |
| | | service |
| | | Can tip with a stored |
| | | payment card |
| | | Automatic tipping |
| Strike Hero (“Hero”) | Worker, server, busker, etc., | Can sign up to become a |
| | who can receive a tip | Hero on Web Site |
| | using their tag which they | Can Sign up to become a |
| | can present to a Striker to | Hero by tapping a tag |
| | make payment | Download the Hero App |
| Strike Web app/site | A Web site for all Strike | Strikers can tip without |
| may also be referred to | activities for Strikers and | signup (like an |
| Strike.tips Web app | Heroes. Suitably, it | ecommerce site, just |
| | supports a logged in mode | checkout) |
| | for Strikers and Heroes | Strikers can sign-up for an |
| | and also supports a | account and register a |
| | logged out/guest mode | card and allow auto |
| | for Strikers, | payment of tips |
| | | Strike Hero can sign-up, |
| | | register Tags. |
| | | Strike Hero can login and |
| | | get access to history, |
| | | balance, tags and Payout. |
| Striker App | An app for Strikers. | Everything the web app |
| | | provides for a striker. May |
| | | include additional features |
| | | not necessarily provided |
| | | by Web App, for example: |
| | | Auto-payment |
| | | Push notifications |
| | | Location search |
| | | (Register Striker Tags for |
| | | ‘reverse tipping” process) |
| Strike Hero App | An app for Strike Heroes | Everything the web app |
| | | provides for a strike hero |
| | | and possibly additional features. |

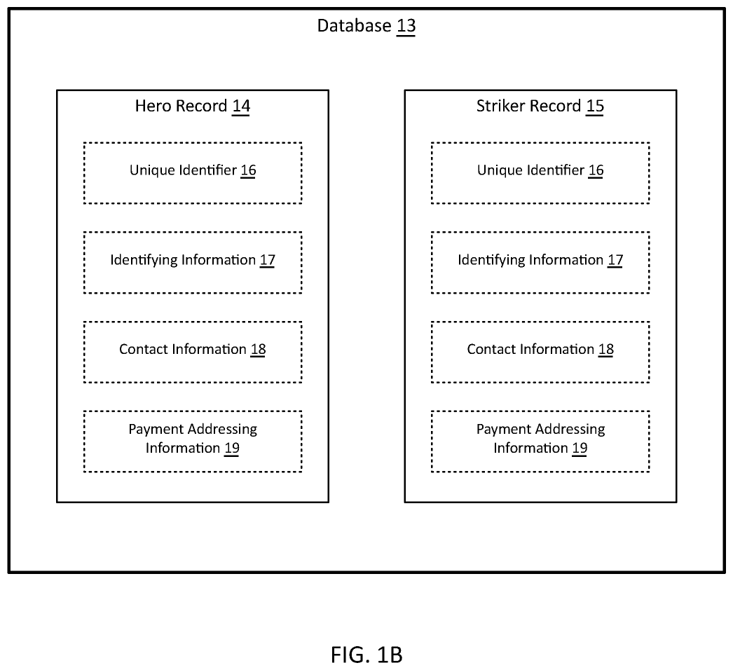

The use of tags makes the process 20 by which a striker 22 can make a payment to a strike hero 24 extremely straight forward as shown in the exemplary process of FIG. 2. The process shown assumes that the strike hero has already registered themselves and their tag 26 with the server. A process which will be described in greater detail below. This process allows a strike hero to use their tag as their own personal “Payment Terminal”.

The process of making a payment commences with a strike hero presenting their tag to the striker. The striker holds the tag against their mobile device 28 (e.g. first user device) where it is read using near field communication 30 by the NFC reader of their mobile device and the URL is read from the tag.

In a first mode of operation 32 where the user has not downloaded the striker App, the application on the mobile phone associated with the NFC reader opens the URL using a web-browser. The format of the URL routes the tag scan to a dedicated landing page, in the example TAGS. This web page may be supported by a suitable server application, e.g. a React Node JS server.

The server application will parse out the tag identifier (hereinafter tagID or unique identifier) and use this to drive the rest of the process.

The status of the tagID may be checked with a database/register of tagIDs and a determination made that the tag (associated with identifier) has previously been associated with a tag hero.

As a result of this determination, the web app presents the user with an interface which allows them to make a payment to the user. As a first step in providing the interface, the web app may perform a check to determine what modes of payment the tag hero accepts. These modes of payment may then be presented to the striker in the web interface allowing them to select a mode of payment from a list. Once a mode of payment is selected, the striker can proceed to make a payment to the strike hero through the interface, similar to conventional on-line payment portal available in on-line stores.

The payment process allows a user to select a payment (tip/gratuity) to be paid to the strike hero.

As part of the payment process, the striker may be allowed to register as user (if not previously registered), login as a registered user or to proceed as a guest. Techniques for implementing these features will be familiar to those skilled in the art. In the case of a registered user for example, the striker may have default methods of payment set-up, for example a previously provided payment card.

Once the method of payment has been selected, a payment request is provided to a payment service (e.g. mobile wallet service, credit/debit card processing service, electronic fund transfer service, cryptocurrency transaction service, e-banking service, etc.) through a payment server (10,12) which may be an on-line web-based service 12 or through a dedicated payment network 10 to which the server is connected. It will be appreciated that different methods of payment may be routed through different payment channels.

Once the payment is approved by the payment channel, the striker interface is updated to confirm that payment has been made. At the same time, the account of the strike hero is credited with the payment less any service charge or other charge if applied. A notification may be sent to the strike hero confirming that they have received the payment and if they are using the strike hero app, this notification 38 may appear on the display of their mobile device.

Where a user is already registered as a striker, they may configure their account to allow for auto-pay. In this mode, the user may pre-select an amount and this amount is automatically paid when a tag is touched using default payment methods. The nature of auto-pay may be configured further to allow automatic payments to a user by tapping.

In a second mode of operation 34, if the striker has the striker app installed on their mobile phone, the striker app may recognise the URL from the tag when it is presented to the NFC reader and in which case, the striker app handles the process rather than the web app but similar to the above. The present application is not directed to the processing of the payment per se, but rather to the manner by which payments may be facilitated without requiring a conventional payment terminal.

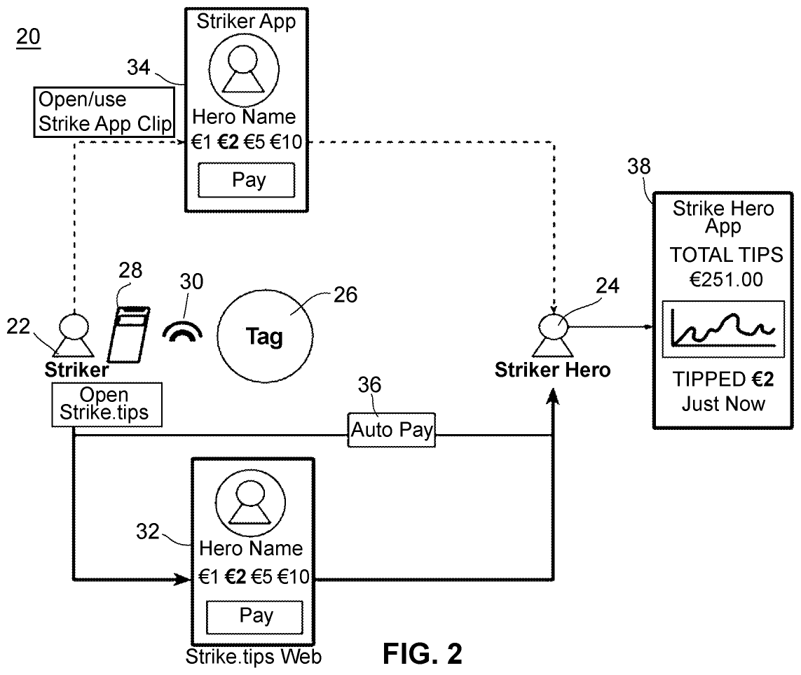

To explain the operation further, the process of tapping a tag will now be explained with reference to the swim lane process flow of FIG. 3, in which the various entities involved are as identified below in Table 2 using letters A-K as identifiers. It will be appreciated that some of these may be omitted or that other entities may be included and is merely to be taken accordingly as exemplary.

The steps of the swim lane process of FIG. 3 are set forth below in Table 3. The process allows for using a payment service for making payment between users and more particularly to facilitate the registration of users for such. The payment service itself may in turn facilitate payments using payment facilitators such as a credit/debit card processing facility or e-banking providers, payment service providers such as PAYPAL, REVOLUT, etc., or mobile wallet services that tie debit/credit cards with a mobile interface (e.g. Apple Pay, etc.).

The method commences generally with the distribution of a plurality of tags. Each of these tags which is suitably an RFID tag which may be read by an NFC reader of a personal communications device such as a mobile phone. Each of the plurality of tags stores tag information comprising an address for a server associated with the payment service and a unique identifier for the respective tag, thus forming a unique URL for each tag.

Generally, each tag will have a unique identifier. Although, in certain limited situations there may be instances where multiple tags have the same unique identifier. However, this is less desirable as it complicates the registration and management process.

An advantage of the approach of the present application is that the tags can be distributed freely by various methods in contrast to for example, payment cards, i.e. credit cards and the like, where the credit cards are issued directly to the user associated with the card. Thus, as an example, the tags can be handed out in public, posted to users requesting them, provided through employers or other distribution channels.

The swim lane process shown in FIG. 3, presupposes that the tags have been distributed and that a user is in possession of one. The next step is registration and making payments.

To make a payment, the user can simply tap the tag against the NFC reader of a smart phone (personal communications device), which in turn reads the tag information from the tag. The smart phone in turn reads the stored URL from tag. The smart phone then proceeds to send a request to the server indicated by the URL. The server in turn is associated with a payment service. The sending of the request may include an initial step of the user providing permission to do so, e.g. by tapping an on-screen message on their phone, based in part on the configuration or security setting of the user on their phone.

At the server, when the request is received, the server performs an initial check, using the unique identifier provided as part of the request (URL), to determine whether the tag has previously been associated with a user.

This results in one of two general possibilities, firstly an identification that a tag has not previously been associated with a user and secondly that a tag has previously been associated with a user. As discussed below, there will be other possibilities including that a tag was previously associated but has since been de-associated.

In the case where, where a tag has not previously been associated with a user, the server responds to the request by sending a web interface, e.g. a web form, to the smart phone. The smart phone in turn displays this web interface using, for example, a browser application. The web interface allows the user to complete registration information with the payment service associated with the server so as to allow the user to associate the tag with themselves. This registration information is sent by the smart phone to the server which completes the registration process by recording the user information in a database of the payment service and associating the tag with the registered user. The registration process with the payment service suitably comprises the user providing payment information by which a user can receive payments. This may for example comprise providing their bank account information to which a payment may be made. Similarly, it may comprise details of an account with a payment service such as PAYPAL™ or REVOLUT™ to which payments can be received. The user may register multiple payment methods. Where a user has previously registered with the server, the web interface may allow the user to log-in at which point they can associate the tag with themselves.

Once a tag is associated with a user, if it is presented at the NFC reader of the smart phone of another user, whilst the request being retrieved from the tag and sent to the server will be identical, the process at the server will be different.

In particular, when the tag information (URL) is transmitted from the second smart phone, the server identifies by comparing the identifier with entries in the database that the tag is associated with the first user.

The server responds to this request by returning a web interface to the second smart phone, which again may be opened with a browser. The web interface allows the second user to make a payment to the first user. In a simple situation, the payment process may involve the user providing their payment card details as they would in a conventional on-line payment and indicating the amount to be paid. Equally, it may facilitate a user making a payment using a payment method such as REVOLUT™ or PAYPAL™. Once processed, the first user's account is credited with the amount (subject to any deductions for service charges or processing fees). The second user may be provided with a plurality of payment options to select from or the service may pre-select a payment option based on what payment details were provided by the first user. Once a payment is received, the server may send a notification to the first user that a payment has been received.

More specific details of various functional entities in the process are set forth below in table 2. It should be noted that these are non-limiting examples, according to some embodiments.

TABLE 2
End User Devices//NFC

| | | |
|---|---|---|
| Tag | A | A Strike tag that is preloaded with a unique ID [TagID]. |
| | | The unique ID is a GUID of the form: |
| | | Base 64 |
| | | RFC 7515 |
| | | For example: |
| | | 3seaBGvW-ESuRPtH9U4W2w |
| | | VMn0Fboxy0K3awyT-L4REw |
| | | V1FL86HIDkWNANmNy_YHtw |
| | | 0zqtLS9I_0GfxSRvOQFymA |
| | | yoDN5m_HrUivMpJvg4kX7A |
| | | E3xnell5U06rvEvHxKVVV9A |
| | | D835NPz4Mk6jQJXL8Vy_wA |
| | | The GUID is on the Tag as a URI with the prefix: |
| | | https://strike.tips/tags/ |
| | | An example of a tag URI: |
| | | https://strike.tips/tags/OzqtLS91_0GfxSRvOQFymA |
| NFC | B | IS014443 compliant RFID tag operating at 13.56 MHz |
| | | NFC Tag with NDEF formatted data up to 137 bytes |
| | | Link is: 25 bytes for the prefix and 22 bytes for the |
| | | tagID == 47 bytes |
| Phone | C | A personal communications device, e.g. a smart phone, |
| | | that has a reader that can read an NFC tag with auto pop-up. |
| | | Android has support with many devices and Apple have |
| | | introduced this feature on their newer iPhones. |

Strike Web Site

| | | |
|---|---|---|
| Web | D | Website located at the URL https//strike.tips is where |
| | | the tag URI will load. |
| | | This swimlane includes the web pages that are driven |
| | | by the system services. |

Strike Platform Services

| | | |
|---|---|---|
| Strike Tag | E | Back-end service to register a Tag with tagID to a User. |
| Registration | | Service handles pushing the Tag Register UI. |
| Service | | |
| Strike Tag Service | F | Back-end service to manage Tags. |
| Strike User | J | Back-end service to register a User. |
| Registration | | Service handles pushing the User Registration User |
| Service | | Interface. |
| Strike User | H | Back-end service to manage Users. |
| Service | | Users primarily include Strikers and Strike Heroes. |
| | | Other users may include Admins and 3rd parties. |
| Strike Notification | J | Back-end service to deliver notifications to Users when |
| Service | | anything happens to their account (e.g. tag registered, |
| | | tag tapped, tip sent, tip received) |
| Strike | K | Back-end service to allow sending of electronic |
| Communication | | communications to users, for example strikers and |
| Service | | strike heroes. These electronic communications may for |
| | | example be emails or text messages (SMSs). |

For ease of explanation, the exemplary swimlane process of FIG. 3 presents the steps as a sequence of boxes with each box represents a step in the process. The process shown is for registration and handles the use case of a Hero tapping a tag to register that tag—if the Hero is not registered, they will register as part of the tag claiming process. The registration steps are as follows, according to various embodiments:

TABLE 3
New or Existing Hero Taps the Tag

| | | |
|---|---|---|
| tag | 101 | A Strike tag waiting to be tapped. |
| | | A Strike tag that is preloaded with a unique ID. |
| | | Branded on one side as needed by the use case. |
| NFC Tag | 102 | NDEF data will be transmitted when tapped |
| (wireless) data | | by a RFID/NFC compatible device. |
| | | The ID is on the Tag as a URL with the prefix: |
| | | https://strike.tips/tags/ |
| | | An example of a tag URL: |
| | | https://strike.tips/tags/0zqtLS9I_0GfxSRvOQFymA |
| Mobile phone | 110 | Smartphone that can read an NFC tag. |
| | | The radio on the phone pulls the NDEF data, |
| | | parses the data for a known format, in this case it's a URI. |
| Native phone push | 111 | The smartphone uses the URI stored on the |
| notification (PN) on | | NDEF ensconced NFC tag to display a push |
| lock screen | | notification on the smartphone within a few |
| | | milliseconds of tapping the tag. |
| | | The replies on the smartphone hardware |
| | | having the NFC reader and automatically |
| | | processing the NDEF data to display the PN. |
| Content of PN with | 112 | The PN contains the following information |
| link | | (the tag ID is variable and unique per tag). |
| | | The tag is written with this data using the |
| | | Strike Tag Service (F). |
| | | An example of a tag URL: |
| | | https://strike.tips/tags/0zqtLS9I_0GfxSRvOQFymA |
| Get Tag by ID | 120 | The Strike Tag Service (F) is used by the |
| | | website (D) to look up the tag ID in the URL. |
| | | When the tag ID is not found, the tag is |
| | | invalid and a “tag Not found (http 40)” page |
| | | is displayed to the user via the web site (D). |
| Find user by TagID | 130 | Once the Strike Tag Service (F) has found |
| | | the tag by its ID, the Strike User Service (H) |
| | | will pull any Hero data already associated |
| | | with the Tag, if one is already registered to this tag. |

Start Tag Registration Process for Hero

| | | |
|---|---|---|
| Owner found? | 141 | Thenext step for the Strike User Service (H) is to |
| | | return the registered Hero user data and set the |
| | | answer to that question to true or false. |
| Y: Owner found | 142 | If the owner is found, proceed to Exist Process step (145). |
| N: Owner not found | 143 | The owner is not found, therefore the Tag is not |
| | | claimed and is not ready to be claimed, The Strike |
| | | User Service (H) sends the Hero to Claim Tag UI (144). |
| Claim Tag UI | 144 | The Web site (D) displays this Claim Tag IU (144) |
| | | which allows the Hero to begin the Tag claiming process. |
| Exit Process | 145 | Exit. |
| | | The process of tapping a registered tag is not part |
| | | of this possess description. |

Start Hero Registration as a User, if needed

| | | |
|---|---|---|
| Existing User? | 150 | The next step for the Web site (D) is to check for if |
| | | the Hero is already logged in, or the Hero can sign |
| | | in to an existing account. The web site (D) will set |
| | | the answer to Hero already registered to true, if |
| | | logged in, or false if not logged in or able to login. |
| Y: Hero already | 151 | The Hero is already logged in and a registered |
| registered | | user. Proceed to Strike Tag Registration Service |
| | | (E) and Start Tag registration (171). |
| N: Hero is not | 152 | The Hero is not logged in and is not found, |
| registered yet | | therefore the Tag is not claimed and is not ready to |
| | | be claimed, The Strike User Service (H) sends the |
| | | Hero to Claim Tag UI (144). |
| Start User | 155 | The Strike User Registration Service (G) is started, |
| Registration | | this displays the Register User IU (160) to the Website (D). |

Register Hero as User

| | | |
|---|---|---|
| Register User UI | 160 | The Web Site (D) displays this Register User UI |
| | | (160) to collect user registration data about a Hero. |
| | | The collected information may include name, |
| | | mobile number, email address, place of work, a |
| | | short bio, tipping preferences, rating wanted, |
| | | payout methods, goals and more. The registration |
| | | UI may also provide for agreement with terms and |
| | | conditions and to user data protection options. |
| | | Once all the registration data is completed, the |
| | | Website (D) will pass this information securely to |
| | | the Strike User Registration Service (G) to register |
| | | the new Hero as a User. |
| User Registered | 161 | The Strike User Registration Service (G) registers |
| | | the new Hero as a User and makes a request to |
| | | the Strike User Service (H) to retrieve the newly |
| | | registered User information for this Hero. |
| Get User | 162 | The Strike User Service (H) retrieves the newly |
| | | registered User information for this Hero and |
| | | passes this to the Strike Tag Registration Service |
| | | (E) to Start Tag Registration (171). |

Start Tag Registration

| | | |
|---|---|---|
| Start Tag | 171 | The Strike Tag Registration Service (E) is used |
| Registration | | when there is an already registered Hero or a new |
| | | user has been registered as a Hero. Now the |
| | | Website (D) has enough information to display the |
| | | Register Tag UI (180). |

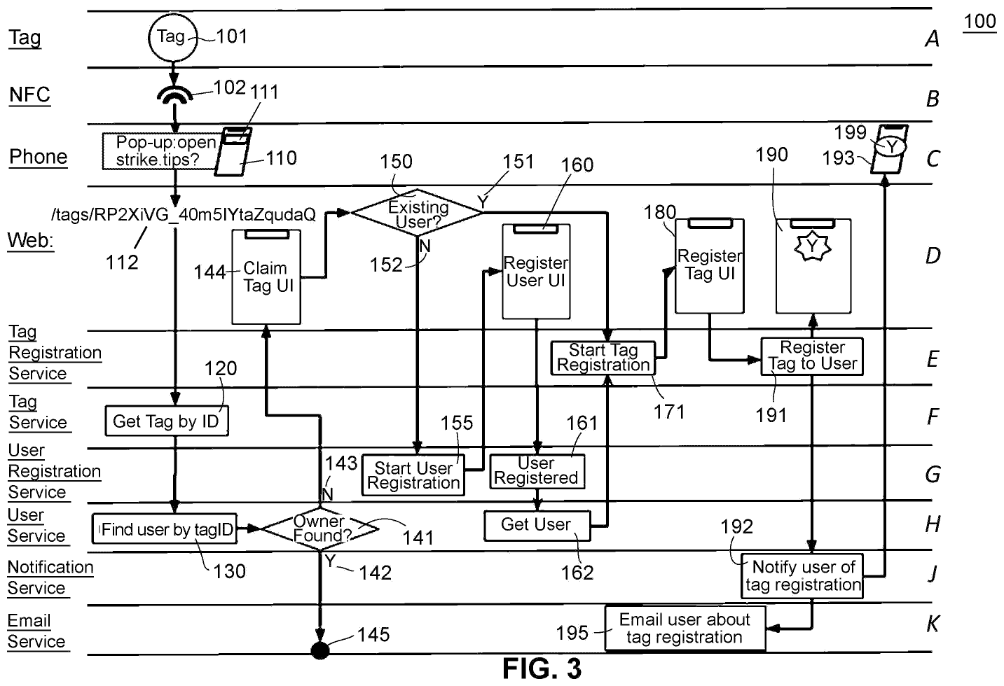

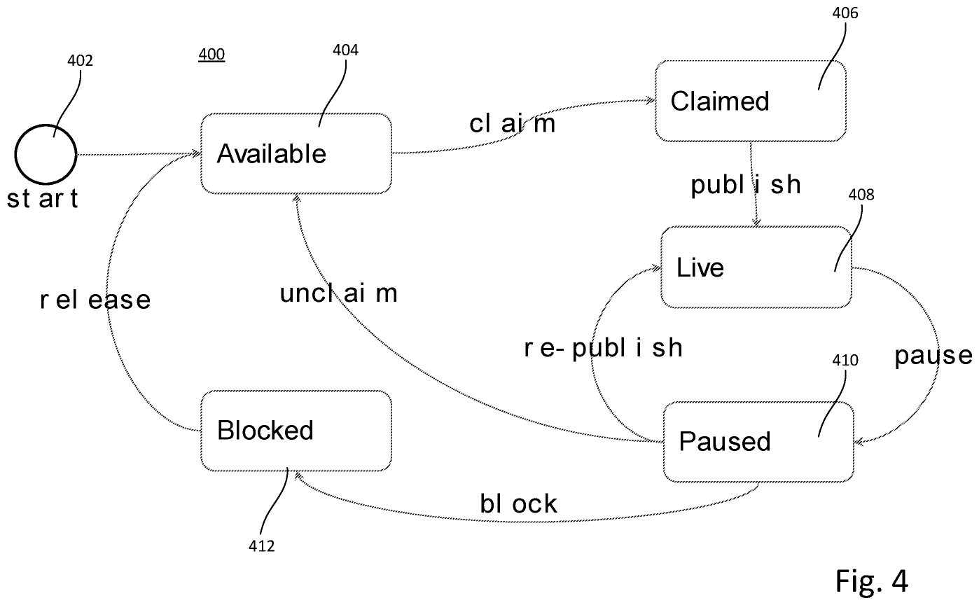

Register Tag

| | | |
|---|---|---|
| Register Tag UI | 180 | The Website (D) displays the Tag information and |
| | | the Hero information provided in a preview of how |
| | | the tag will appear to Strikers when tapped. If the |
| | | Hero is satisfied with the details then can confirm |
| | | and complete the registration of the tag. Once |
| | | registration is completed, the tag is live and |
| | | available for Strikers to use instantly to make a |
| | | payment to a Hero. |
| Tag Registered UI | 190 | The Website (D) displays the Tag information and |
| | | the Hero information provided in a preview of how |
| | | the tag will appear to Strikers when tapped. |
| | | The Registered Tag UI displays all the details of |
| | | the tag and options to change the tag's state. |
| | | Details of a tag life cycle are shown in FIG. 4. |
| Register Tag to | 191 | The Strike Tag Registration Service (E) may now |
| User | | register the Tag to the Hero user. |
| | | This makes this tag tappable by a Striker and tips |
| | | may be paid directly to the Hero's account. |
| | | It will be appreciated that Hero accounts may be |
| | | managed as with users generally in any account |
| | | service. An Account life-cycle detailed flow is |
| | | illustrated in FIG 5. As an example of a step, an |
| | | account may be frozen temporarily(508), for |
| | | example where suspected fraud is detected by an |
| | | abnormal pattern of transactions. This in turn may |
| | | result the account being unfrozen where the |
| | | transactions are explained or closed where they cannot be. |
| Notify user of tag | 192 | The Strike Notification Service (J) creates a |
| registration | | number of notification messages in formats, such |
| | | as for example email, SMS, WHATSAPP ™ and a |
| | | push notification. The Strike Notification Service |
| | | (J) schedules these notifications to be delivered at |
| | | the appropriate to the Hero via the appropriate |
| | | channel. In the case of email, this would be using |
| | | the Strike Email Service (K) and in the case of |
| | | push notifications to the Phone (C). |
| Email user about | 195 | The Strike Email Service (K) sends an email about |
| tag registration | | the tag registration to the Hero user's email. |
| Hero's phone | 193 | The Strike Notification Service (J) sends a native |
| | | or website (D) push notification about the tag |
| | | registration to the Hero user's Phone (C) or Website (D). |
| Confirmation push | 199 | The Hero user's Phone (C) or Website (D) displays |
| notification | | the message created by the Strike Notification Service (J). |
| message | | |

An advantage of the method of the present application is that tags may be distributed generally without any need for pre-association and that these tags once associated with a hero (claimed) they may be used as a payment terminal by the hero to receive payments from strikers. An exemplary life cycle 400 of a tag is shown in FIG. 4 in which at the start 400, the tag is encoded with the GUID. Once encoded with the GUID it is available 404 for use. After a hero has registered 406 the tag for themselves the tag is “claimed”. Once claimed (associated with the user), the tag is then published as live 408 meaning that if tapped by a striker, a payment process will ensue. According to various embodiments, other statuses may be applied to a tag for operational reasons including blocking 412 and pausing 410, which are explained below in Table 4.

TABLE 4

| State | Conditions | Actions |
|---|---|---|
| available | When created, the tag may | claim: A Hero can claim any |
| | be ‘available’ | Available tag which then becomes |
| | A tag may be unclaimed or | ‘claimed’ . Tag enters the ‘claimed’ |
| | released to become | state. Hero is informed of state |
| | ‘available’ again. | change. |
| claimed | When claimed, a tag is | publish: makes tag tappable. Tag |
| | owned but is not yet ready | enters the ‘live’ state. Hero is |
| | to be tapped for payment. A | informed of state change. |
| | message may be displayed | |
| | to say “tag is claimed, | |
| | waiting for Hero”. | |
| live | When claimed, a tag can be | pause: makes tag untappable. Tag |
| | tapped for payment. | enters the ‘paused’ state. Hero is |
| | | informed of state change. |
| paused | When paused, a tag is still | re-publish: makes a tag tappable |
| | claimed by the Hero but | again, as when published. Tag |
| | maydisplay an error to the | enters the ‘live’ state. Hero is |
| | user when tapped by a | informed of state change. |
| | Striker. When tapped by the | unclaim: releases the tag and |
| | owning Hero, they will be | makes it available to be claimed |
| | prompted to ‘re-publish’ the | by the same Hero or any other |
| | tag. | Hero. Tag enters the ‘available’ |
| | | state. Hero is informed of state |
| | | change. block: the tag enters the |
| | | ‘blocked’ state. Hero is informed |
| | | of state change. |
| blocked | When blocked the tag may | release: Only a Strike |
| | no longer be interacted with | Administrator can release a |
| | by the Hero. The tag is | blocked tag so that it can be made |
| | not claimable. An error | available again. Hero is not |
| | message stating that the | informed on the state change. |
| | tag is ‘blocked’ is displayed | |
| | tapped by a Striker or Hero. | |

Similar to the tags, an account of hero may have an associated life cycle 500 as shown in FIG. 5. After the start 502 of the life cycle, the steps and stages of which are set forth below in Table 5, according to some embodiments.

TABLE 5

| State | Conditions | Actions |
|---|---|---|
| created | When created (504), the | verify: A Hero can verify the |
| | account may be registered to | account which then become |
| | a Hero, transactions can be | ‘active’. Account enters the ‘active’ |
| | executed and value | state. Hero is informed of state |
| | accumulated in the | change. It will be appreciated that |
| | pendingBalance but the | verification may be performed |
| | account availableBalance | using methods conventionally |
| | may be set to 0. | employed for verifying user |
| | | accounts. |
| active | When an account is verified, | freeze: makes it so an account's |
| | the account is determined to | availableBalance cannot be |
| | be active (506). Thereafter, | withdrawn. Account enters the |
| | transactions can be executed | ‘active’ state. Hero is informed of |
| | and value accumulated in the | state change. |
| | pendingBalance and the | |
| | account availableBalance | |
| | may be incremented as and | |
| | when transactions “clear”. | |
| | The availableBalance may | |
| | be withdrawn. | |
| paused | When an account is paused | unfreeze: makes an account |
| | (508), transactions can be | active again, as when first verified. |
| | executed and value | Account enters the ‘active’ state. |
| | accumulated in the | Hero is informed of state change. |
| | pendingBalance and the | close: the Account enters the |
| | account availableBalance | ‘closed’ state (510). Hero is |
| | may be incremented as and | informed of state change. Account |
| | when transactions “clear”. | may be closed by the Hero or the |
| | The availableBalance may | Strike Administrator. |
| | not be withdrawn. Hero | |
| | retains full access to the | |
| | account. | |
| closed | When closed the account | Only a Strike Administrator can |
| | may no longer be interacted | interact with a closed account. |
| | with by the Hero. The | Heroes cannot access the closed |
| | account is no longer ‘owned’ | account. |
| | by the Hero. All access to the | There may be an appeal process |
| | account is removed, | and a closing account redemption |
| | | process, where allowed by law and |
| | | risk. |

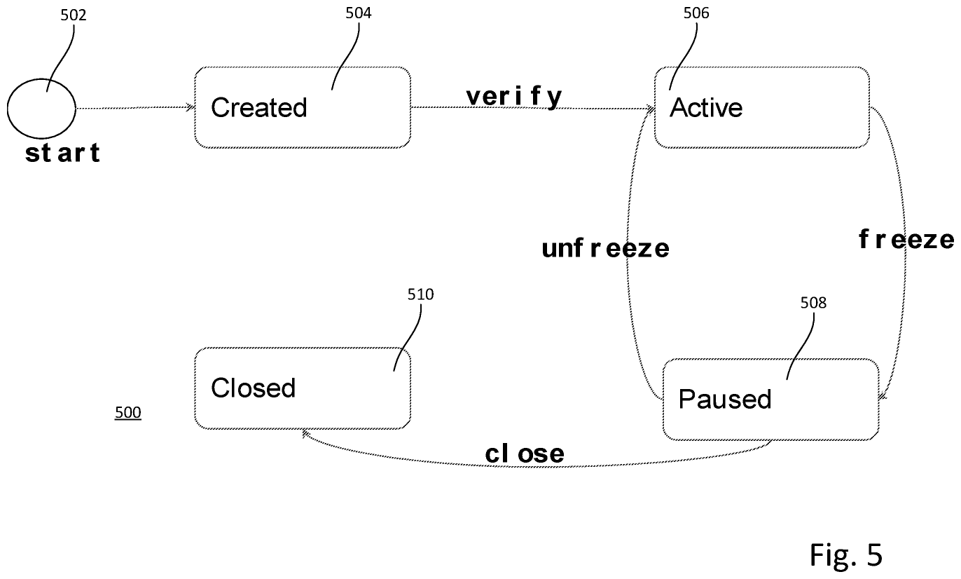

Similar to the tags and an account of hero, a tap of a tag may be considered to have an associated life cycle 600 from a start point 602 as shown in FIG. 6, the steps and stages of which are set forth below in Table 6.

| State | Conditions | Actions |
|---|---|---|
| Created | When created, the Tap | verify. The Striker (anonymous user) |
| (604) | is created from a Tag, | completes the Tap details and, once |
| | the Tap is the basic unit | verified, enters the Ready state. |
| | of transaction for a tip. | (Verification can happens automatically |
| | | when all details are ready) |
| Ready (606) | When a Tap is ready it | start_payment: Striker initiates the |
| | can be used to pay for | payment with an interaction, or using a |
| | a tip. | stored payment method (no user |
| | | interaction). Tap enters the In Progress |
| | | state. |
| in_progress | When a tap is in | payment_complete: completes the |
| (608) | progress, we must | payment for the tip and the Tap is in its |
| | wait for the result of final state. | |
| | the payment. This can | payment_stopped: the payment |
| | be: | stopped for some reason -- the Stiker |
| | a)Successful | may be able to retry. |
| | b)Failed (many reasons) | |
| | c)Cancelled | |
| | d)Timed out | |
| Successful | When payment is | A Strike Administrator can interact with |
| (614) | made, the tip has been | a successful Tap. Heroes and Strikers |
| | paid and the Tap is | cannot access the Tap. |
| | complete -- Taps in this | |
| | state may appear in | |
| | Striker and Hero tipping | |
| | history. | |
| Failed (610), | When a payment is | retry: The Striker can re-try the Tap |
| held (612) | stopped for an above | (when failed but not when held) subject |
| | reason, it enters this | to some rules, value and time limits. |
| | state. Or Held by | |
| | system or Admin. | |

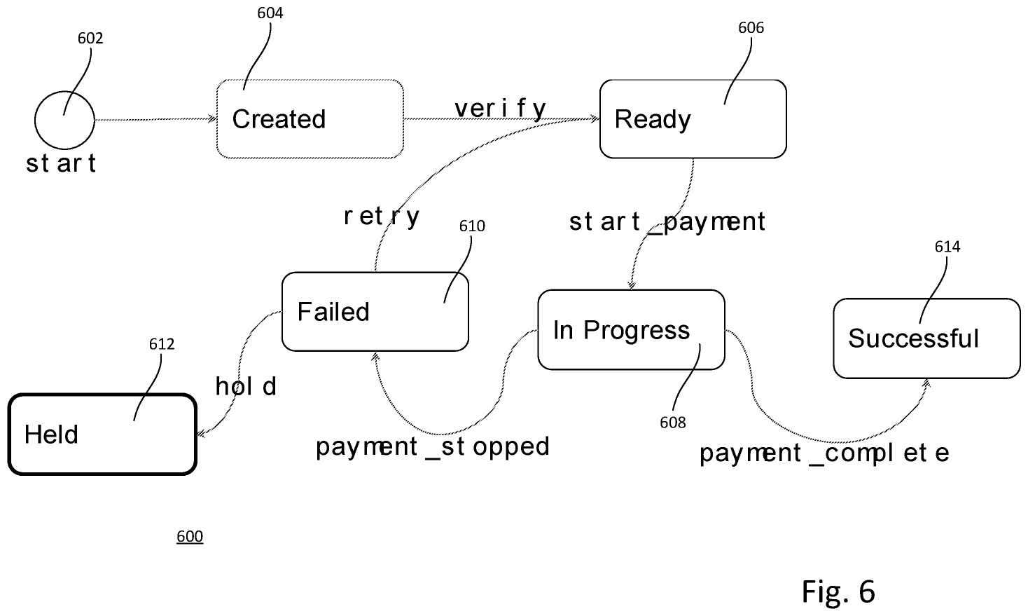

For instance, the method steps 110,111, 112 and 193, 199 of FIG. 3 can be implemented on a personal communication device 700 as shown in FIG. 7. It may be implemented as software, such as a computer program being executed within the communication device 700 and instructing the communication device 700 to conduct the steps.

The communication device 700 comprises a processor module 702, an input module such as a keypad 704 which may be a virtual keyboard presented on an output module such as a display 706.

The processor module 702 is coupled to a first communication unit 708 for communication with a cellular network 710. The first communication unit 708 can comprise, but is not limited to comprising, a subscriber identity module (SIM) card loading bay. The cellular network 710 may, for example, be a 3G, 4G or 5G network.

The processor module 702 is further coupled to a second communication unit 712 for connection to a local area network 714. For example, the connection can enable wired/wireless communication and/or access to e.g. the Internet or other network systems such as Local Area Network (LAN), Wireless Personal Area Network (WPAN) or Wide Area Network (WAN). The second communication unit 712 can include but is not limited to a wireless network card or an Ethernet network cable port.

The processor module 702 is further coupled to a second communication unit 712 for connection to a local area network 714. For example, the connection can enable wired/wireless communication and/or access to e.g. the Internet or other network systems such as Local Area Network (LAN), Wireless Personal Area Network (WPAN) or Wide Area Network (WAN). The second communication unit 712 can include but is not limited to a wireless network card or an Ethernet network cable port.

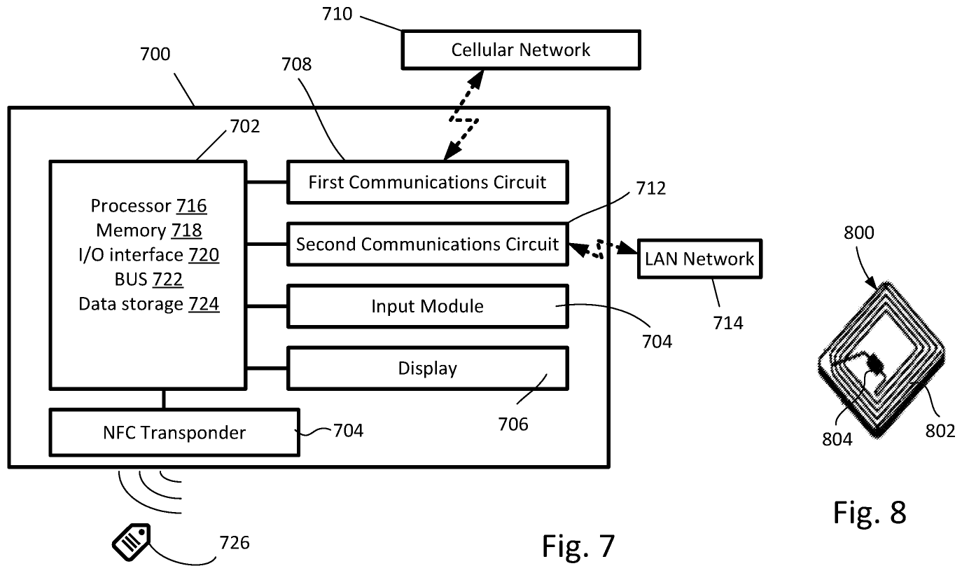

The processor module 702 is further coupled to an NFC transponder 704 which is configured to read information from a tag 726 as explained above. An exemplary tag 800 shown in FIG. 8 which may employed in steps 101 and 102 of FIG. 3, comprises an antenna 800 which is adapted to inductively receive power from the NFC transponder and to enable communications between a microchip 804 of the tag and the NFC transponder. The microchip has instructions stored in memory which allow it to respond to the NFC transponder. Also stored in memory may be the previously discussed GUIDs comprising the URL associated with the tag.

Returning to the personal communications device, the processor module 702 in the example includes a processor 716, a Random Access Memory (RAM) 718 and a Read Only Memory (ROM) 720. The processor module 702 also includes one or more Input/Output (I/O) interfaces 720, for communicating with the various other components of the device.

The components of the processor module 702 typically communicate via an interconnected bus 722 and in a manner known to the person skilled in the relevant art.

An application, which facilitates the method steps performed on the communications device according to the various embodiments mentioned above, as explained above downloaded from a server and stored in memory 724 for installation. The installed application is then loaded into memory 718 and controlled in its execution by the processor 716. It will be appreciated that when a striker app or strike hero has not been downloaded to the communications device

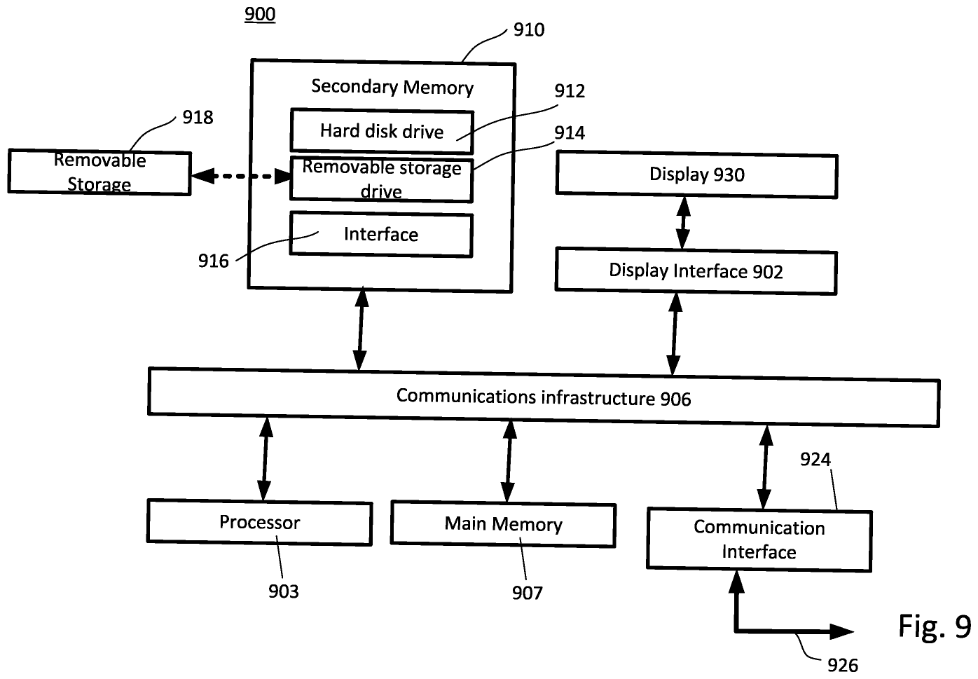

FIG. 9 shows an exemplary computing device 900, to realize a server executing the feature D to K as shown in FIG. 3. The following description of the computing device 900 is provided by way of example only and is not intended to be limiting. Therefore, one or more elements or components of the computing device 900 may be omitted. Also, one or more elements or components of the computing device 900 may be combined together. Additionally, one or more elements or components of the computing device 900 may be split into one or more component parts.

With reference to FIG. 9, the exemplary computing device 900 includes a processor 903 for executing software routines. Although a single processor is shown for the sake of clarity, the computing device 900 may also include a multi-processor system. The processor 903 is connected to a communication infrastructure 906 for communication with other components of the computing device 900. The communication infrastructure 906 may include, for example, a communications bus, cross-bar, or network.

The computing device 900 further includes a main memory 907, such as a RAM, and a secondary memory 910. The secondary memory 910 which is accessed through an interface 916, may include, for example, a hard disk drive 912. It may also include removable storage drive (not shown), which may include a floppy disk drive, a magnetic tape drive, an optical disk drive, or the like. The removable storage drive reads from and/or writes to a removable storage unit in a well-known manner. The removable storage unit 918 may include a floppy disk, magnetic tape, optical disk, or the like, which is read by and written to by removable storage drive 914. As will be appreciated by persons skilled in the relevant art(s), the removable storage unit 918 includes a computer readable storage medium having stored therein computer executable program code instructions and/or data.

In an alternative implementation, the secondary memory 910 may additionally or alternatively include other similar means for allowing computer programs or other instructions to be loaded into the computing device 900.

The computing device 900 also includes at least one communication interface 924. The communication interface 924 allows software and data to be transferred between computing device 900 and external devices via a communication path 926. In various implementations, the communication interface 924 permits data to be transferred between the computing device 900 and a data communication network, such as a public data or private data communication network. The communication interface 924 may be used to exchange data between different computing devices 900 which such computing devices 900 form part an interconnected computer network. Examples of a communication interface 924 can include a modem, a network interface (such as an Ethernet card), a communication port, an antenna with associated circuitry and the like. The communication interface 924 may be wired or may be wireless. Software and data transferred via the communication interface 924 are in the form of signals which can be electronic, electromagnetic, optical or other signals capable of being received by communication interface 924. These signals are provided to the communication interface via the communication path 926.

As shown in FIG. 9, the computing device 900 further includes a display interface 902 which performs operations for rendering images to an associated display 930.

As used herein, the term “computer program product” may refer, in part, to removable storage unit 918, removable storage unit 922, a hard disk installed in hard disk drive 912, or a carrier wave carrying software over communication path 926 (wireless link or cable) to communication interface 924. A computer readable medium can include magnetic media, optical media, or other recordable media, or media that transmits a carrier wave or other signal. These computer program products are devices for providing software to the computing device 900. Computer readable storage medium refers to any non-transitory tangible storage medium that provides recorded instructions and/or data to the computing device 900 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 900. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on Websites and the like.

The computer programs (also called computer program code) are stored in main memory 907 and/or secondary memory 910. Computer programs can also be received via the communication interface 924. Such computer programs, when executed, enable the computing device 900 to perform one or more steps as described above with reference to FIG. 3. The computer programs, when executed, enable the processor 903 to associate a first user with a tag and then allow a second user to use the tag to make a payment to the first user. Accordingly, such computer programs may represent controllers of the computing device 900.

Software may be stored in a computer program product and loaded into the computing device 900 using the removable storage drive 914 or the hard disk drive 912. Alternatively, the computer program product may be downloaded to the computing device 900 over the communications path 926. The software, when executed by the processor 903, causes the computing device 900 to perform the necessary operations to execute the method steps as shown in the figures.

It will be appreciated by a person skilled in the art that numerous variations and/or modifications may be made to the present invention as shown in the specific embodiments without departing from the spirit or scope of the invention as broadly described. As an example, whilst the description above is with respect to making a payment from one user to another, it will be appreciated that the system may also be used by charities, churches and similar bodies for receiving donations where the tags are registered to the body. Similarly, various enhancements are possible depending on specific requirements of users. For example, a specific application is to allow heroes receive tips from a striker, for which a typical scenario is to allow a waiting person or bus person receive a tip from a customer. However, in certain restaurants, tips are shared between the staff. It will be appreciated that this can be facilitated on the server side, for example, by allowing a hero registering to associate themselves with a group of other heroes and payments can be shared among the group. Accordingly, the above description is to be considered merely exemplary. The present embodiments are, therefore, to be considered in all respects to be illustrative and not restrictive.

1. A method for facilitating mobile contactless payment, comprising:
providing a read-only Near Field Communication “NFC” tag encoded with a Uniform Resource Location “URL” containing a server address and a unique identifier unique to the NFC tag;
receiving a first query sent from a hero mobile phone in response to the hero mobile phone reading the NFC tag;
parsing the first query to extract the unique identifier;
determining whether the unique identifier is available or live by searching a database for the unique identifier;
if the unique identifier is available but not activated, activating the NFC tag and unique identifier in the database through the hero mobile phone by associating the unique identifier with a hero record in the database, the hero record comprising hero identifying information, hero contact information, and at least first hero payment addressing information associated with at least one hero payment service, wherein the unique identifier is not the at least first payment addressing information;
receiving a second query sent to the URL over a network from a first customer mobile phone in response to the first customer mobile phone reading the NFC tag;
parsing the second query to extract the unique identifier;
determining whether the unique identifier is activated by searching a database for the unique identifier;
retrieving the hero record stored within the database and associated with the unique identifier in response to determining that the unique identifier is activated;
sending a payment interface to the first customer mobile phone indicating the at least one hero payment service of the hero record;
receiving a payment service selection from the first customer mobile phone;
redirecting the first customer mobile phone to a payment server associated with the selected payment service using the payment addressing information of the hero record;
receiving a query sent to the URL over the network from a second customer mobile phone in response to the second customer mobile phone reading the NFC tag;
sending a payment interface to the second customer mobile phone indicating the at least one hero payment service of the hero record;
receiving a payment service selection from the second customer mobile phone;
redirecting the second customer mobile phone to the payment server associated with the selected payment service using the payment addressing information of the hero record;
wherein the at least one hero payment service comprises a mobile wallet service.

2. The method of claim 1, wherein any sensitive payment information requested through the first customer mobile phone is sent directly to the payment server.

3. The method of claim 1:
wherein the query sent to the URL from the first customer mobile phone comprises a striker identifier associated with a striker record within the database, the striker record comprising at least payment addressing information specific to a striker user associated with the striker identifier;
wherein the payment interface sent to the first customer mobile phone indicates at least one payment service common to the striker record and to the hero record; and
wherein redirecting the first customer mobile phone to the payment server associated with the selected payment service uses the payment addressing information of the hero record and of the striker record.

4. The method of claim 1, wherein the payment addressing information of the hero record is associated with a plurality of payment services, each payment service associated with a different payment server.

5. A method for facilitating mobile contactless payment, comprising:
providing a read-only Near Field Communication “NFC” tag encoded with a Uniform Resource Location “URL” containing a server address and a unique identifier unique to the NFC tag;
receiving a first query sent to the URL over a network from a first customer mobile device in response to the first customer mobile device reading the NFC tag;
parsing the query to extract the unique identifier;
determining whether the unique identifier activated by searching a database for the unique identifier;
retrieving a hero record stored within the database and associated with the unique identifier in response to determining that the first unique identifier is activated, the hero record associated with a hero user and comprising at least hero payment addressing information specific to the hero user and associated with at least one hero payment service;
sending a payment interface to the first customer mobile device indicating the at least one hero payment service of the hero record;
receiving a payment service selection from the first customer mobile device; and
redirecting the first customer mobile device to a payment server associated with the selected hero payment service using the hero payment addressing information of the hero record.

6. The method of claim 5, wherein any sensitive payment information requested through the first customer mobile device is sent directly to the payment server.

7. The method of claim 5, further comprising:
prior to receiving the first query sent to the URL over the network from the first customer mobile device:
receiving a hero query sent to the URL over a network from a hero mobile device in response to the hero mobile device reading the NFC tag;
parsing the hero query to extract the unique identifier;
determining whether the unique identifier is activated by searching a database for the unique identifier; and
claiming the unique identifier through the hero mobile device and identifying the unique identifier as activated in response to determining the first unique identifier is available, wherein claiming the unique identifier comprises:
requesting from a hero user through the hero mobile device, hero identifying information, hero contact information, and the hero payment addressing information associated with the at least one hero payment service; and
creating the hero record within the database, the hero record associated with the hero user and comprising the unique identifier, the hero identifying information, the hero contact information, and the hero payment addressing information specific to the hero user.

8. The method of claim 7, wherein the second customer mobile device is redirected to an interface provided directly from a payment server, for each of the at least one first hero payment service identified by the second hero user.

9. The method of claim 5, wherein the at least one hero payment service comprises a mobile wallet service.

10. The method of claim 5, wherein the at least one hero payment service comprises a card processing service.

11. The method of claim 5, wherein the hero payment addressing information of the hero record is associated with a plurality of payment services, each payment service associated with a different payment server.

12. The method of claim 5:
wherein the query sent to the URL from the first customer mobile device comprises a striker identifier associated with a striker record within the database, the striker record comprising at least striker payment addressing information specific to a striker user associated with the striker identifier;
wherein the payment interface sent to the first customer mobile device indicates at least one payment service common to the striker record and the first hero record; and
wherein redirecting the first customer mobile device to the payment server associated with the selected payment service uses both the payment addressing information of the hero record and the striker record.

13. A system for facilitating mobile contactless payment, comprising:
a Near Field Communication “NFC” tag encoded with a Uniform Resource Location “URL” containing a server address and a unique identifier unique to the NFC tag;
a database comprising a hero record associated with a hero user and comprising the unique identifier, payment addressing information specific to the hero user and associated with at least one payment service;
a server comprising a processor, a memory, and a network interface communicatively coupled to a network through the server address, the server also communicatively coupled, through the network, to at least one payment server associated with each of the at least one payment service, the server configured to:
receive a query sent to the URL over the network from a first customer mobile device in response to the first customer mobile device reading the NFC tag;
parse the query to extract the unique identifier;
determine whether the unique identifier is activated by searching the database for the unique identifier;
retrieve the hero record from the database in response to determining that the unique identifier is activated;
send a payment interface to the first customer mobile device indicating the at least one payment service of the hero record;
receive a payment service selection from the first customer mobile device; and
redirect the first customer mobile device to the payment server associated with the selected payment service, using the payment addressing information of the hero record.

14. The system of claim 13, wherein any sensitive payment information requested through the first customer mobile device is sent directly to the payment server.

15. The system of claim 13, wherein the server is further configured to, prior to receiving the query from the first customer mobile device:
receive a hero query sent to the URL over the network from a hero mobile device in response to the hero mobile device reading the NFC tag;
claim the unique identifier through the hero mobile device and identifying the unique identifier as activated in response to determining the unique identifier is available, wherein claiming the unique identifier comprises:
requesting from a hero user through the hero mobile device, hero identifying information, hero contact information, and the hero payment addressing information associated with the at least one hero payment service; and
creating the hero record within the database, the hero record associated with the hero user and comprising the unique identifier, the hero identifying information, the hero contact information, and the hero payment addressing information specific to the hero user.

16. The system of claim 15, wherein the server is further configured to redirect the second user device to an interface provided directly from a payment server for each of the at least one second hero payment service identified by the second hero user.

17. The system of claim 13, wherein the at least one hero payment service comprises a mobile wallet service.

18. The system of claim 13, wherein the at least one hero payment service comprises a card processing service.

19. The system of claim 13, wherein the payment addressing information of the hero record is associated with a plurality of hero payment services, each hero payment service associated with a different payment server.

20. The system of claim 13:
wherein the query sent to the server address from the first customer mobile device comprises a striker identifier associated with a striker record within the database, the striker record comprising at least payment addressing information specific to a striker user associated with the striker identifier;
wherein the payment interface sent to the first consumer mobile device indicates at least one payment service common to the striker record and to the hero record; and
wherein redirecting the first consumer mobile device to the payment server associated with the selected payment service uses the payment addressing information of the hero record and of the striker record.
